(19) United States
(12) Patent Application Publication
(10) Pub. No.: US 2003/0172038 A1
(43) Pub. Date: Sep. 11, 2003

(54) Method for securing payment for deliveries and services in open networks

(76) Inventors: Armin Sawusch, Halle/Saale (DE); Holger Zimmermann, Hartha (DE); Ronald Schmieder, Bad Durrenberg (DE)

Correspondence Address: Striker Striker & Stenby, 103 East Neck Road, Huntington, NY, 11743, US

(21) Appl. No.: 10/258,098

(22) PCT Filed: Apr. 14, 2001
(86) PCT No.: PCT/DE01/01484

(30) Foreign Application Priority Data
Apr. 20, 2000 (DE) 100 19 884.8

(51) Int. Cl. G06F 17/60

(52) U.S. Cl. 705/67

(57) ABSTRACT

The invention describes a method for securing payment of amounts of different levels by means of an arbitrary payment method for arbitrary goods, and in particular for delivering services that are to be paid for to a customer via packet-oriented open networks, in particular the internet, including the usual security standards and encryption methods, with the usual access software, regardless of the operating system, in which after a customer request, a ticket pair (6; 10) is generated by a merchant (3), and a first ticket (6) is transmitted indirectly via a customer (1) to a payment provider (4) and a form (7) for payment confirmation is transmitted by the payment provider (4) to the customer (1). After the required information about the customer and about the desired service (6) has been entered and the filled-out form has been transmitted along with the first ticket (6), these are on hand as payment authorization at a payment provider (4) so that the applicable amount can be booked to the merchant's account. That the bookkeeping operation is done once the customer data have been validated by the payment provider (4) and the second ticket (10), transmitted from the merchant (3) to the payment provider (4), is on hand as a response to the request of the payment provider (4) for validation of the first ticket (6) by the merchant (3), which, modified with customer data by the payment provider (4), was transmitted to the merchant. That the customer (1), after payment, receives access to the service (5) via the network (2), once the second ticket (10), transmitted by the payment provider (4) to the customer (1), has been correlated and validated by the merchant (3) by interaction with the merchant and the release has been granted.

The invention describes securing payment of amounts of the most various levels for arbitrary goods, in particular for delivery via packet-oriented networks, including the usual security standards.

In the internet, as one of the most widely used versions of a packet-oriented network, business is assuming ever broader forms, and the sensitive data of all those involved has to be protected. Yet mutual identification, authentication, authorization and verification of transactions must also be possible. In the prior art, many solutions for relatively secure e-commerce in the internet are known.

The development of a payment system with real-time verification and authentication with improved confidentiality and security for large to small amounts in a closed network with partial networks via an open network is described for instance in International Patent Disclosure WO 99/66436. The payment system includes node points where customer data are stored and by way of which customers are connected to sellers, so that secure electronic business can be transacted. The customer data can be recorded by banks and other operators of payment systems. Operators of payment systems, such as business/shopping cards, can authorize use by third parties within firmly defined limits, so that monitoring and control are also provided for. A central contact registry operates a registration service, which shows which node point is connected to which customer. The payment system includes a dual-key transaction system, in which confirmed instructions must arrive separately and completely independently of one another from both the customer and the seller, before the transaction is concluded by a method accepted by both sides. Within the payment system, the customer, the seller, and associated payment methods and payment systems are known, and they are registered along with a limit by an authorization administrator. Both the customer and the seller can select the payment method and form of currency used to conclude the transaction, and the payment is made within a closed system, without one of those involved having access to or awareness of the details of the payment system of the other. Test runs in real time, which pertain to all those involved, are implemented in which the customer, the seller and banks can trace transactions, generate records, and trigger repayments for such secure transactions. The payment system is independent of both the software and the hardware and can be implemented in any network configuration for any electronic or digital transaction, using mobile phones, palmtops and digital television, for payments of any type in e-commerce.

The expense for achieving the payment system described, with storage of the data in memory in local node points, is considerable. Given the requirement for registration of all the customers and merchants, the capability of access to the system is restricted considerably.

Still another payment system for open e-commerce for securely conducting transactions between customers and merchants over networks is described in U.S. Pat. No. 5,557,518. The system has a customer fiduciary agent, which communicates securely with a first monetary module, and a merchant fiduciary agent, which communicates with a second monetary module. Both fiduciary agents can set up a first encrypted secure session, and both monetary modules can set up a second encrypted secure session. The merchant fiduciary agent transmits electronic goods, such as data, to the customer fiduciary agent, and the first monetary module transmits electronic money to the second monetary module. The monetary module informs its fiduciary agents of the success of the payment transaction, and the customer can use the electronic goods purchased, examples being telephoning or receiving data. These payment methods require the inclusion of multiple fiduciary agents with buffer storage of the data, so that once again considerable expense for realizing this is needed, and fiduciary agents in the form of buffer memories must always be set up for every customer and every merchant.

The object of the invention, while including conventional security standards and encryption methods, is to develop a method for securing payment in amounts of different levels for arbitrary goods, preferably for ordering and delivering over open networks, in particular the internet, by means of arbitrary virtual payments, which is simple for both customers and merchants to handle, can be operated in real time with fast access times using conventional internet access software, independently of the operating system, and is open to all.

This object is attained by the characteristics recited in claim 1. Preferred refinements can be learned from the dependent claims.

The essence of the invention resides in securing the payment for deliveries and services over an open packet-oriented network, in particular the internet, from a customer by a merchant or vendor by means of an arbitrary payment method, with the aid of the presence of tickets that are generated by a merchant, transmitted between the merchant and the customer, the customer and a payment provider, and the payment provider and the merchant, and validated by interaction of those involved with one another, in that after a customer request, preferably two tickets generated by the merchant are on hand, in the form of random numbers linked with further information, of which one ticket is sent back to the customer and after the requisite information about the customer and about the desired delivery or service has been entered is present in the form of a payment confirmation form furnished by a payment provider and the transmission of the ticket and form data on the part of the payment provider for booking the applicable amount to the account of the merchant. For transmitting the information for payment confirmation, it is also possible to use an independent further channel in addition to the channel over which the purchase and payment were transacted. The bookkeeping operation is done once the customer data have been validated by the payment provider and the second ticket transmitted by the merchant has been transmitted as a response to the request by the payment provider for validation of the first ticket by the merchant, which the payment provider modified with customer data, has been transmitted to the payment provider. After payment, the customer receives access to the delivery or service over the network, once the second ticket, transmitted to the customer by the payment provider, has been correlated as well as validated by the merchant by interaction with the merchant, and the release has been granted.

In a variant, the first ticket can comprise a fixed index and a hash value about the index and a random number, and only the second ticket, comprising the index and the random number, is generated, and for authentication and validation, the hash value about the index and the second ticket can be used.

At least the transmission of the sensitive customer data to the payment provider is done over a secure connection which encrypts the request by the payment provider for validation of the first ticket by the merchant.

It is along the lines of the invention to use, as the payment provider, an existing customer bookkeeping system, for instance in billing systems belonging to a mobile radio operator, credit card issuer, or others, or to use access to an equivalent kind of system.

Favorably, monitoring for the uniqueness of the random numbers generated by the merchant for the tickets is done. After the transaction has been completed, once the customer has received the service or delivery, the generated tickets can be erased.

Alternatively, the ticket can be provided with a time stamp, which limits it validity, making repeated use within the period of validity possible, and with the system, the release of a content region or a service can be achieved over a defined period of time.

The payment can also be secured by linking various media or communications terminals, such as PCs, to mobile phones, or only with mobile phones, which have browsers for date-based recording languages; an order is triggered at a merchant at a PC by conventional internet access software or mobile phone, and the payment for the order is activated by forwarding the customer identification data by mobile phone, using conventional security systems.

The advantages of the invention reside in particular in the simple handling, which however is secure for both the merchant and the customer, of the payment for services or deliveries with real-time validation in packet-based networks with virtually immediate access capability of the customer, using conventional security standards with various terminal devices using arbitrary operating systems as well as arbitrary conventional access software and the most various kinds of payment methods for amounts of arbitrary level, depending on the scope of availability. Access to sensitive customer data is not possible, because of the secure communication between the customer and the payment provider. Assembling usage profiles of individual customers is furthermore made substantially more difficult, because only information on the payment event is forward to the payment provider, and the merchant has no access to the payment information. The possibility of the secure payment described is afforded to any participant who may have even only a communications connection to an arbitrary terminal device for access to the network of an arbitrary provider through whose billing system payments for usage can be billed.

Even small and extremely small amounts can be transferred in a way that is economical to the customer.

For the merchant, only a simple software installation is necessary, while for the customer, the usual network access software suffices, without additional components.

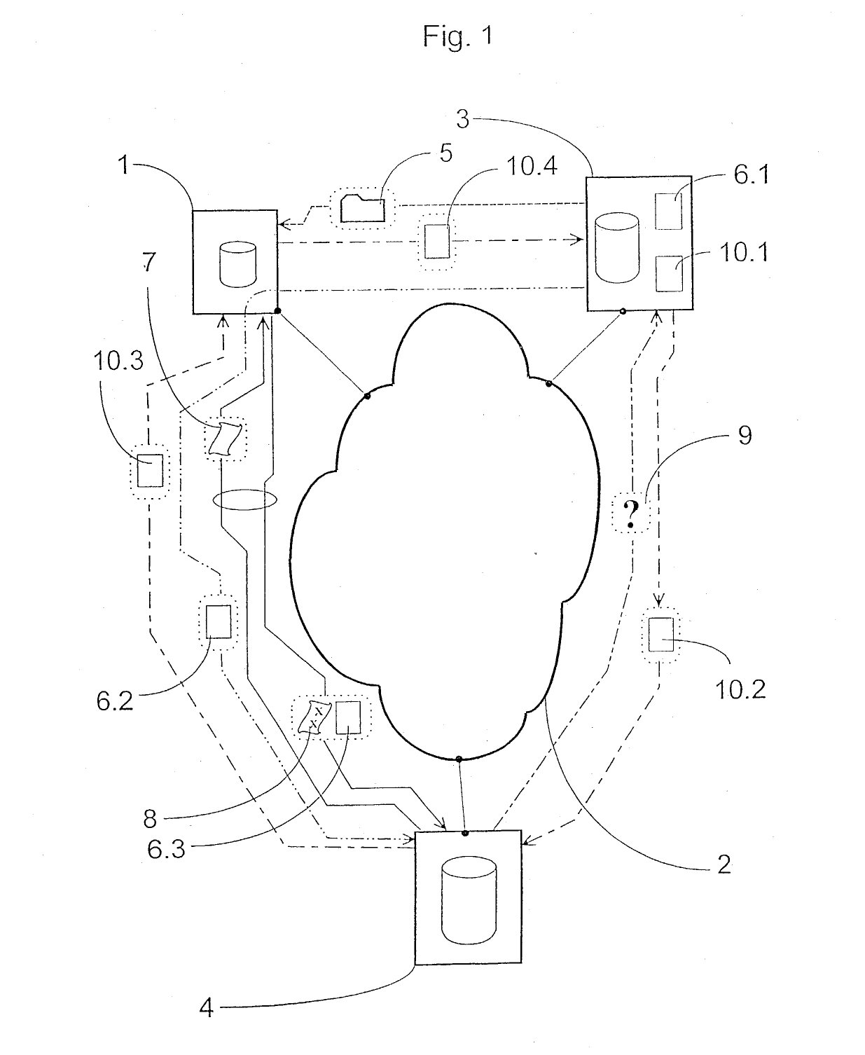

The invention will now be described in further detail in terms of an exemplary embodiment in conjunction with FIG. 1, which schematically shows the course of a transaction, with payment and delivery of data over a network.

In FIG. 1, a customer 1 with a terminal device, for instance in the form of a PC, is connected over a network 2, in particular the internet, to a merchant 3 and a payment provider 4. A browser installed on the customer's PC, or a WAP browser on a mobile data terminal, loads an internet page of the merchant 3 with a link to a further page, by way of which a reference is furnished to a service 5 that must be paid for, for instance in the form of downloading data files; the payment is favorably done as a function of a data volume. After the service 5 that has to be paid for has been selected by the customer 1, the merchant 3 generates the data for two tickets, whose uniqueness is subjected to monitoring in the further course of the method. A first ticket 6 (6.1 through 6.3) is sent indirectly, over the PC of the customer 1, to the payment provider 4. The payment provider sends a form 7 to the customer 1 over a secure channel. The form 7 on the one hand includes an offer by the merchant 3 that is binding to the customer 1, and within the form 7, the type and scope of the service 5, or the goods to be delivered by the merchant 3 are listed, and specific authorization data can be entered on the other hand by the customer 1, data that are necessary in order to uniquely and securely authenticate the customer 1 to the payment provider 4, if this is not done implicitly, for instance by means of the connection data. Alternatively to the use of a form 7, the payment authorization can be done over a further channel, for instance by means of an SMS message or by a call center call.

A filled-out form 8 is sent back to the payment provider 4 as payment authorization, along with the first ticket 6, over a secure connection, and from the information of the customer 1, upon positive identity, the payment provider performs the validation and generates an request 9 to the merchant 3 for validating the first ticket 6, and this request is sent encrypted. The merchant 3 checks the amount for the service 5 requiring payment that the customer 1 has selected and validates the first ticket 6, if there is agreement between the originally generated amount and the correct amount. The payment provider receives a second ticket 10 (10.1 through 10.4) as a response from the merchant 3, whereupon this second ticket 10 is forwarded directly to the customer 1 and also triggers the booking of the amount. The customer 1 forwards the second ticket 10 to the merchant 3, which after a positive outcome of the monitoring as to whether the ticket was indeed prepared by it, furnishes the customer with the service 5 requiring payment, for instance for downloading, or causes the goods to be shipped to the customer.

After the conclusion of the transmission of the service 5 requiring payment, or of the shipment of the goods, the tickets 6; 10 can be erased again by the merchant.

In a variant, different, mutually independent communications terminals can be used in combination with one another for secure payment, for instance in that the first ticket 6 is sent by the merchant 3 to a mobile telephone that has WAP belonging to the customer 1, who sends it, authorized as a payment instruction, to the payment provider 4, and then the delivery of the download or goods is done as described.

It is also conceivable for the merchant 3 and the payment provider 4 to be identical, and billing systems with suitable limits located at a service provider for telecommunications that simultaneously acts as a payment provider 4 can be used to pay for services 5 that require payment.

List of Reference Numerals

1 Customer

2 Network

3 Merchant

4 Payment provider

5 Service

6 First ticket (6.1 through 6.3)

7 Form

8 Filled-out form

9 Request

10 Second ticket (10.1 through 10.4)

1. A method for securing payment of amounts of different levels by means of an arbitrary payment method for arbitrary goods, and in particular for delivering services that are to be paid for to a customer via packet-oriented open networks, in particular the internet, including the usual security standards and encryption methods, with the usual access software, regardless of the operating system,
characterized in that
after a customer request, a ticket pair (6; 10) is generated by a merchant (3), and a first ticket (6) is transmitted indirectly via a customer (1) to a payment provider (4);
thereupon a form (7) for payment confirmation is transmitted by the payment provider (4) to the customer (1);
after the required information about the customer and about the desired service (6) has been entered and the filled-out form has been transmitted along with the first ticket (6), these are on hand as payment authorization at a payment provider (4) so that the applicable amount can be booked to the merchant's account;
that the bookkeeping operation is done once the customer data have been validated by the payment provider (4) and the second ticket (10), transmitted from the merchant (3) to the payment provider (4), is on hand as a response to the request of the payment provider (4) for validation of the first ticket (6) by the merchant (3), which, modified with customer data by the payment provider (4), was transmitted to the merchant; and
that the customer (1), after payment, receives access to the service (5) via the network (2), once the second ticket (10), transmitted by the payment provider (4) to the customer (1), has been correlated and validated by the merchant (3) by interaction with the merchant and the release has been granted.

2. The method of claim 1, characterized in that
the first ticket (6) comprises a fixed index and a hash value about the index and a random number, and the second ticket (10), comprising the index and the random number, itself is generated, and for authentication and validation, the hash value about the index and the second ticket (10) are used.

3. The method of one of claims 1 or 2, characterized in that
the transmission of the sensitive data from the customer (1) to the payment provider (4) over a secure channel and the request (9) by the payment provider (4) for validation of the first ticket (6) by the merchant (3) are done in encrypted form.

4. The method of claims 1-3, characterized in that
monitoring for the uniqueness of the tickets (6; 10) generated by the handle (3) is done.

5. The method of claims 1-4, characterized in that
the tickets (6; 10) can be provided with a time stamp for repeated use within a specified period of time.

6. The method of claims 1-5, characterized in that
at the end of the business transaction, once the customer has received the service (5), the generated tickets (6; 10) can be erased.

7. The method of claims 1-6, characterized in that
an arbitrary customer bookkeeping in a mobile radio operator, credit card issuer, service provider or billing system functions as the payment provider (4).

8. The method of claims 1-7, characterized in that
the authorization for paying for the service (5) is activated by the combined cooperation of various independent communication terminals of various media.
